(19) United States
(12) Patent Application Publication
(10) Pub. No.: US 2023/0082433 A1
(43) Pub. Date: Mar. 16, 2023

(54) DIGITAL FILTER DEVICE

(71) Applicant: NEC Corporation, Minato-ku, Tokyo (JP)

(72) Inventor: Atsufumi SHIBAYAMA, Tokyo (JP)

(73) Assignee: NEC Corporation, Minato-ku, Tokyo (JP)

(21) Appl. No.: 17/802,251

(22) PCT Filed: Mar. 26, 2021
(86) PCT No.: PCT/JP2021/012985

§ 371 Date: Aug. 25, 2022

(30) Foreign Application Priority Data
Mar. 26, 2020 (JP) 2020-055544

(51) Int. Cl. G06F 17/14

(52) U.S. Cl. CPC G06F 17/142

(57) ABSTRACT

A fast Fourier transform device comprises: a first transform means including a first butterfly computation processing means that performs butterfly computation processing and outputs a plurality of sets of first output data in a first order; and a first data rearrangement processing means. The first butterfly computation processing means includes a plurality of radix-n butterfly computation processing means (where n is a multiple of 2), the number of the plurality of radix-n butterfly computation processing means being more than or equal to the number of the plurality of sets, and the plurality of sets of the first output data are output in the first order from the plurality of radix-n butterfly computation processing means.

### TECHNICAL FIELD

The present invention relates to a digital filter device performing digital signal processing and more particularly to a fast Fourier transform device performing a fast Fourier transform or an inverse fast Fourier transform.

### BACKGROUND ART

Important types of processing in digital signal processing include fast Fourier transform (hereinafter referred to “FFT”) processing. For example, a frequency domain equalization (FDE) technology is known as a technology for compensating for waveform distortion in signal transmission in wireless communication and wired communication. In frequency domain equalization, first, time-domain signal data are transformed into frequency-domain data by a fast Fourier transform, and then filter processing for equalization is performed. Then, waveform distortion in the original time-domain signal is compensated for by retransforming the data undergoing the filter processing into time-domain signal data by an inverse fast Fourier transform (hereinafter referred to as “IFFT”). FFT and IFFT are hereinafter denoted as “FFT/IFFT” when the two are not distinguished.

“Butterfly computation” is generally used in FFT/IFFT processing. For example, Patent Literature 1 (PTL1) describes an FFT device using butterfly computation. PTL1 also describes “twiddle multiplication” to be described later, that is, multiplication using a twiddle factor.

For example, butterfly computation by Cooley-Tukey described in Non-Patent Literature 1 (NPL1) is well-known as an efficient FFT/IFFT processing method. However, an FFT/IFFT by Cooley-Tukey having a large number of points makes a circuit complex. Therefore, for example, FFT/IFFT processing is performed by decomposing the FFT/IFFT into two smaller FFTs/IFFTs by using the prime factor method described in Non-Patent Literature 2 (NPL2).

For example, FIG. 19 illustrates a dataflow 500 of a 64-point FFT decomposed into two stages of radix-8 butterfly processing by using the prime factor method. The dataflow 500 includes data sorting processing 501, butterfly computation processing 502 and butterfly computation processing 503 each set of processing including a total of eight sets of radix-8 butterfly computation processing, and twiddle multiplication processing 504.

In the dataflow in FIG. 19, input time-domain data x(n) (n=0, 1, . . . , 63) are Fourier-transformed into frequency-domain signals X(k) (k=0, 1, . . . , 63) by FFT processing. Illustration of part of the dataflow is omitted in FIG. 19. The basic configuration of the dataflow in FIG. 19 remains the same when IFFT processing is performed.

Implementation of the entire dataflow in FIG. 19 requires a huge circuit scale. Therefore, a method of implementing the entire FFT processing by repetitively using a circuit for implementing part of the processing in the dataflow according to required processing performance is generally employed.

For example, in the dataflow in FIG. 19, when an FFT device performing FFT processing on eight pieces of data in parallel (hereinafter simply referred to as “in 8-data parallel”) is generated as a physical circuit, 64-point FFT processing can be implemented by eight rounds of repetitive processing in total.

The eight rounds of repetitive processing refer to processing corresponding to each of partial dataflows 505a to 505h performed on eight pieces of data being sequentially performed and are specifically performed as follows. Specifically, processing corresponding to the partial dataflow 505a is first performed, processing corresponding to the partial dataflow 505b is secondly performed, and processing corresponding to the partial dataflow 505c (unillustrated) is thirdly performed. From there onward, subsequent processing up to processing corresponding to the eighth partial dataflow 505h is sequentially performed similarly. The 64-point FFT processing is implemented by the processing described above.

In butterfly computation, data arranged in a sequential order are read in an order conforming to a predetermined rule and are processed. Therefore, rearrangement of data is required in butterfly computation, and a random access memory (RAM) circuit is mainly used for circuit implementation. For example, Patent Literature 2 (PTL2) describes an FFT device performing rearrangement of data using a RAM circuit in butterfly computation. Further, with respect to an FFT computation device with reduced memory usage, for example, Patent Literature 3 (PTL3) describes a speedup technology by parallel processing of butterfly computation.

Further, Patent Literature 4 (PTL4) describes an optimization technology of an output timing and an output order of processing results of FFT processing, the technology being aimed at speedup of processing in a stage subsequent to an FFT device and reduced power consumption of the FFT device.

### CITATION LIST

### Patent Literature

[PTL1] Japanese Patent Application Laid-Open No. Hei08-137832
[PTL2] Japanese Patent Application Laid-Open No. 2001-056806
[PTL3] Japanese Patent Application Laid-Open No. 2012-022500
[PTL4] Japanese Patent No. 6358096

### Non Patent Literature

[NPL1] J. W. Cooley, J. W. Tukey, “An Algorithm for the Machine Calculation of Complex Fourier Series,” Mathematics of Computation, US, American Mathematical Society, April 1965, Vol. 19, No. 90, pp. 297 to
[NPL2] D. P. Kolba, “A Prime Factor FFT Algorithm Using High-Speed Convolution,” IEEE Transaction on Acoustics, Speech, and Signal processing, US, IEEE Signal Processing Society, August 1977, Vol. ASSP-25, No. 4, pp. 281 to 294

### SUMMARY OF INVENTION

### Technical Problem

With respect to frequency-domain signals X(k) (k=0, 1, . . . , N−1) being Fourier-transformed by FFT processing, computations may be performed among a plurality of X(k)'s with different values of k. For example, a computation may be performed between two pieces of data X(k) and X(N−k). In this case, X(k) and X(N−k) are input signals of a certain computation and therefore are desirably input in the same cycle or in cycles as close to each other as possible. The reason is that every input signal needs to be aligned in order to start a computation. Thus, there is a specific combination of a plurality of signals acquired as a result of FFT processing, input of the signals to a stage subsequent to the FFT processing at the same time or at timings as close to each other as possible being effective for speeding up processing in the subsequent stage. Furthermore, it is generally effective to output a plurality of signals to a subsequent stage in an output order optimum for processing in the subsequent stage.

However, the FFT circuits described in NPLs 1 and 2 do not output signals X(k) being FFT processing results in an order taking into consideration speedup of computation in a subsequent stage and output the FFT processing results X(k) in order of completion of computation. Therefore, X(k) and X(N−k) may be output in cycles being apart by a plurality of cycles being more than the minimum output interval, that is, one cycle. For example, in an extreme case of N=128, signals being apart by 127 cycles may be output, such as a case of X(0) and X(127).

In order to perform a computation between X(k) and X(N−k) in such a case, a data sorting means for outputting X(k) and X(N−k) in the same cycle or in cycles close to each other needs to be provided after the FFT circuit.

FIG. 20 illustrates a configuration example of an FFT device 600 in which a data sorting processing unit 602 is connected to an FFT unit 601 as a subsequent stage. Taking into consideration a case of signals being output in cycles being apart from each other by the number of cycles close to the number of FFT points as described above, the data sorting processing unit 602 needs to include a storage means that can hold data for at least one FFT block. Furthermore, it is desirable that output timings or an output order of a plurality of processing results to a subsequent stage be optimized for processing in the subsequent stage.

However, each of the FFT circuits described in NPL1 and NPL2 does not include a data sorting circuit and therefore cannot control output timings nor an output order of processing results. Therefore, there is a problem that processing latency in the entire processing including the FFT processing increases.

Output timings of a plurality of results acquired by FFT processing are not taken into consideration in FFT devices in PTL2 and PTL3 either. Rearrangement of input data to a butterfly computation unit is performed in the FFT device in PTL2. The FFT computation device in PTL3 aims at speedup by parallelizing butterfly computations. However, an output order of signals resulting from FFT processing is not particularly taken into consideration in the FFT devices in PTL2 and PTL3 either. Therefore, signals are output in order of completion of computation by the FFT processing, and the order is not necessarily suitable for speedup of processing in a subsequent stage. Accordingly, the FFT devices in PTL2 and PTL3 also have a problem similar to the above that processing latency in the entire processing increases.

As described above, the technologies disclosed in NPLs 1 and 2, and PTL2 and PTL3 have a problem that output timings and an output order of processing results of FFT processing cannot be optimized.

PTL4 describes an FFT device that can provide input of data to be processed and output of processing results in any order, and the FFT device can output outputs X(k) and X(N−k) with a time difference within one cycle at the most. On the other hand, PTL4 discloses a method for implementing FFT processing by repetitively using, a plurality of number of times, one butterfly computation circuit assigned to each stage of two-stage butterfly processing in an FFT dataflow decomposed into two stages of butterfly processing by the prime factor method but does not clarify an optimum configuration in a case of further increasing a degree of parallelism of processing in order to further speed up the FFT processing.

Effectiveness of optimization of timings or an output order of processing results also holds for a case of performing processing using results of IFFT processing in a stage subsequent to the IFFT processing.

Furthermore, a case of an output order of results of processing in a stage previous to FFT processing or IFFT processing not being optimum for an execution order of computations performed in the FFT processing or the IFFT processing may be considered. In such a case, it is effective to rearrange input data from the previous stage in such a way that the resulting order is an optimum order for the FFT processing or the IFFT processing.

### OBJECT OF INVENTION

An object of the present invention is to provide a fast Fourier transform device and a digital filter device with low processing latency in digital signal processing using a fast Fourier transform and with a small circuit scale and low power consumption of a circuit for implementing the digital signal processing.

### Solution to Problem

In order to achieve the aforementioned object, a fast Fourier transform device according to the present invention includes:

a first transform means for generating a plurality of sets of a plurality of pieces of first output data by performing a fast Fourier transform or an inverse fast Fourier transform, and outputting the generated data in a first order, the first transform means including a first butterfly computation processing means for performing butterfly computation processing and outputting the plurality of sets of a plurality of pieces of first output data in the first order; and

a first data sorting processing means for, based on an output order setting, rearranging, in a second order, the plurality of sets of a plurality of pieces of first output data output in a first order from the first butterfly computation processing means in the first transform means, wherein

the first butterfly computation processing means includes a plurality of radix-n butterfly computation processing means (where n is a multiple of 2) a number of which is equal to or more than a number of the plurality of sets, and the plurality of sets of a plurality of pieces of first output data are output in the first order from the plurality of radix-n butterfly computation processing means.

A digital filter device according to the present invention includes:

the fast Fourier transform device;

a complex conjugate generation means for generating second complex data including a conjugate complex number for every complex number constituting a plurality of pieces of frequency-domain first complex data generated by the fast Fourier transform device by Fourier-transforming the plurality of pieces of first input data being input time-domain complex numbers;

a filter coefficient generation means for generating first and second frequency-domain filter coefficients being complex numbers from input first, second, and third input filter coefficients being complex numbers;

a first filter means for performing filter processing on the first complex data with the first frequency-domain filter coefficient and outputting third complex data;

a second filter means for performing filter processing on the second complex data with the second frequency-domain filter coefficient and outputting fourth complex data; and

a complex conjugate synthesis means for generating fifth complex data by synthesis from the third complex data and the fourth complex data.

### Advantageous Effects of Invention

The present invention can provide a fast Fourier transform device and a digital filter device with low processing latency in digital signal processing using a fast Fourier transform and with a small circuit scale and low power consumption of a circuit for implementing the digital signal processing.

### BRIEF DESCRIPTION OF DRAWINGS

FIG. 1 is a block diagram illustrating a configuration of an FFT device 10 according to a first example embodiment of the present invention.

FIG. 2 is a diagram illustrating data sets arranged in a sequential order according to the first example embodiment of the present invention.

FIG. 3 is a diagram illustrating data sets arranged in a bit reverse order according to the first example embodiment of the present invention.

FIG. 4 is a diagram illustrating a computation order of sets of radix-8 butterfly computation processing according to the first example embodiment of the present invention.

FIG. 5 is a diagram illustrating data sets arranged in an optimized data set sequential order according to the first example embodiment of the present invention.

FIG. 6 is a diagram illustrating a computation order of sets of the radix-8 butterfly computation processing according to the first example embodiment of the present invention.

FIG. 7 is a block diagram illustrating a data sorting processing unit 100 being a configuration example of a first data sorting circuit 11 according to the first example embodiment of the present invention.

FIG. 8 is a block diagram illustrating a data sorting processing unit 200 being a configuration example of a second data sorting processing circuit 12 according to the first example embodiment of the present invention.

FIG. 9 is a block diagram illustrating a configuration of an FFT device 20 according to a second example embodiment of the present invention.

FIG. 10 is a diagram illustrating a computation order of sets of radix-8 butterfly computation processing according to the second example embodiment of the present invention.

FIG. 11 is a diagram illustrating data sets arranged in an optimized data set sequential order according to the second example embodiment of the present invention.

FIG. 12 is a diagram illustrating a computation order of sets of the radix-8 butterfly computation processing according to the second example embodiment of the present invention.

FIG. 13 is a block diagram illustrating a configuration example 400 of a digital filter circuit according to a third example embodiment of the present invention.

FIG. 14 is a block diagram illustrating a configuration of a complex conjugate generation circuit 415 according to the third example embodiment of the present invention.

FIG. 15 is a block diagram illustrating a configuration of a filter circuit 421 according to the third example embodiment of the present invention.

FIG. 16 is a block diagram illustrating a configuration of a filter circuit 422 according to the third example embodiment of the present invention.

FIG. 17 is a block diagram illustrating a configuration of a complex conjugate synthesis circuit 416 according to the third example embodiment of the present invention.

FIG. 18 is a block diagram illustrating a configuration of a filter coefficient generation circuit 441 according to the third example embodiment of the present invention.

FIG. 19 is a diagram illustrating a dataflow 500 in 64-point FFT processing using two-stage butterfly computation.

FIG. 20 is a block diagram illustrating a configuration of an FFT device 600 including a data sorting circuit.

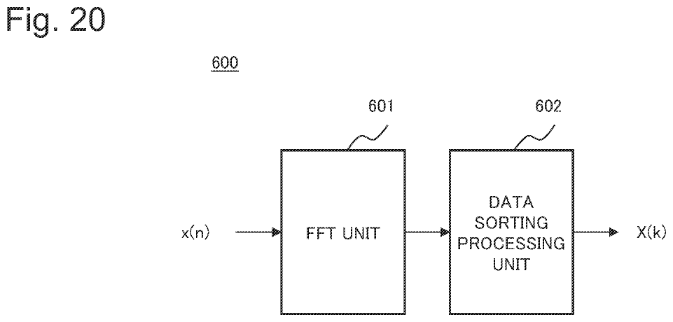

FIG. 21 is a block diagram illustrating a configuration of an FFT device according to an example embodiment based on a superordinate concept.

### EXAMPLE EMBODIMENT

Preferred example embodiments of the present invention will be described in detail with reference to drawings.

### First Example Embodiment

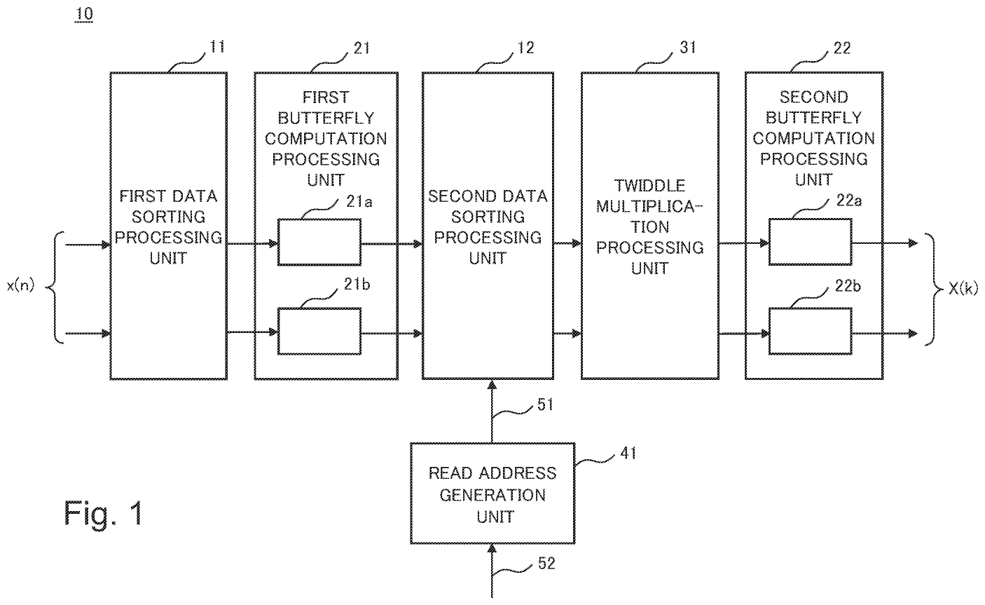

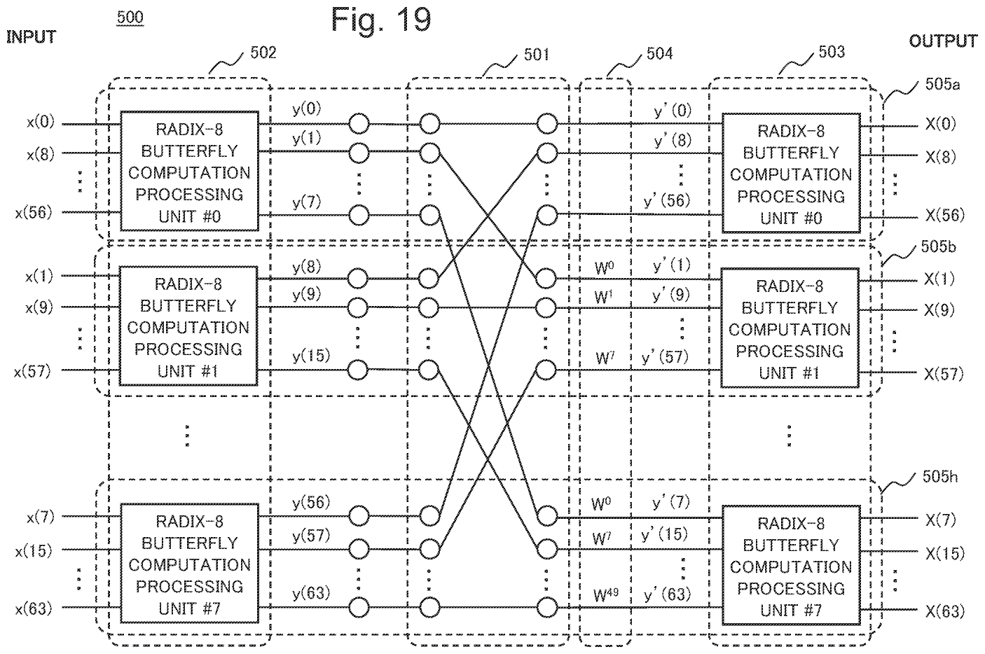

FIG. 1 is a block diagram illustrating a configuration example of an FFT device 10 according to a first example embodiment of the present invention. The FFT device 10 processes a 64-point FFT decomposed into two stages of radix-8 butterfly processing, by a pipeline circuit method in accordance with the dataflow 500 illustrated in FIG. 19. The FFT device 10 inputs time-domain data x(n) (n=0, 1, . . . , N−1), generates frequency-domain signals X(k) (k=0, 1, . . . , N−1) by Fourier-transforming x(n) by FFT processing, and outputs X(k). Note that N is a positive integer denoting an FFT block size.

The FFT device 10 includes a first data sorting processing unit 11 and a first butterfly computation processing unit 21 as an example of a first transform means, a second data sorting processing unit 12 as an example of a first data sorting processing means, a twiddle multiplication processing unit 31, a second butterfly computation processing unit 22, and a read address generation unit 41. The FFT device 10 performs pipeline processing on first data sorting processing, first butterfly computation processing, second data sorting processing, twiddle multiplication processing, and second butterfly computation processing.

The first data sorting processing unit 11 and the second data sorting processing unit 12 are buffer circuits for data rearrangement. The first data sorting processing unit 11 performs rearrangement of a data sequence based on data dependency in an FFT processing algorithm, before the first butterfly computation processing unit 21. Similarly, the second data sorting processing unit 12 inputs a read address 51 and performs rearrangement of a data sequence based on data dependency in the FFT processing algorithm, after the first butterfly computation processing unit 21. Furthermore, with respect to the output X(k) of the FFT device 10, the second data sorting processing unit 12 performs sorting processing for outputting outputs X(k) and X(N−k) in the same cycle for any k being equal to or greater than 1 and equal to or less than N−1, in addition to the aforementioned rearrangement.

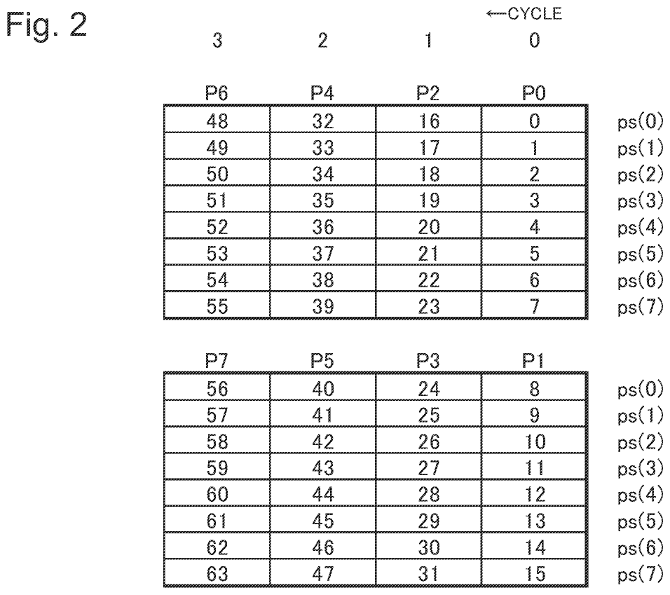

It is assumed that the FFT device 10 performs 64-point FFT processing in 16-data parallel. In this case, the FFT device 10 inputs time-domain data x(n), generates frequency-domain signals X(k) Fourier-transformed by FFT processing, and outputs X(k). At this time, as the input data x(n), 64 pieces of data in total are input in units of 16 pieces of data in a period of four cycles in an order illustrated in FIG. 2. Note that each of numbers from 0 to 63 indicated as a content of a table in FIG. 2 means an index n of x(n).

Specifically, 16 pieces of data in total including eight pieces of data x(0), x(1), . . . , and x(7) constituting a data set P0 and eight pieces of data x(8), x(9), . . . , and x(15) constituting a data set P1 are input in a zeroth cycle. Then, 16 pieces of data in total including eight pieces of data x(16), x(17), . . . , and x(23) constituting a data set P2 and eight pieces of data x(24), x(25), . . . , and x(31) constituting a data set P3 are input in a first cycle. From there onward, data constituting data sets P4 to P7 are similarly input in a second cycle and a third cycle.

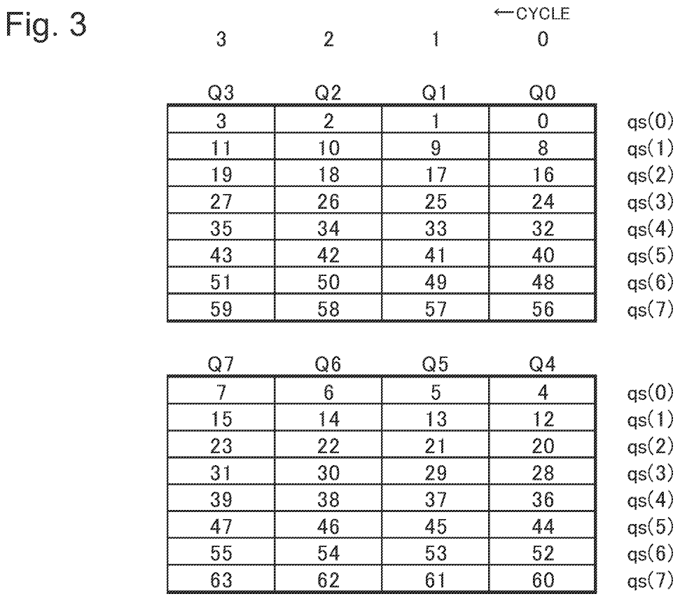

Next, the first data sorting processing unit 11 rearranges a “sequential order” illustrated in FIG. 2 being an input order of input data x(n) into a “bit reverse order” illustrated in FIG. 3 being an input order to the first butterfly computation processing unit 21.

The bit reverse order illustrated in FIG. 3 is related to an input data set to the radix-8 butterfly computation processing 502 in the first stage in the dataflow diagram illustrated in FIG. 19. Specifically, the first data sorting processing unit 11 outputs 16 pieces of data in total including eight pieces of data x(0), x(8), . . . , and x(56) constituting a data set Q0 and eight pieces of data x(4), x(12), . . . , and x(60) constituting a data set Q4 in a zeroth cycle. Then, the first data sorting processing unit 11 outputs 16 pieces of data in total including eight pieces of data x(1), x(9), . . . , and x(57) constituting a data set Q1 and eight pieces of data x(5), x(13), . . . , and x(61) constituting a data set Q5 in a first cycle. From there onward, the first data sorting processing unit 11 similarly outputs data constituting data sets Q2 and Q6, and Q3 and Q7 in a second cycle and a third cycle.

The “sequential order” and the “bit reverse order” will be specifically described. The “sequential order” refers to an order related to the eight data sets P0 to P7 illustrated in FIG. 2. Each data set Ps (s=0, 1, . . . , 7) is composed of sequentially arranged eight pieces of data from ps(0) to ps(7) where ps(i) is expressed by

ps(i)=8s+i

The data sets are arranged in an order of P0, P1, P2, P3, P4, P5, P6, and P7, according to progress of processing cycles. In other words, the sequential order refers to generating s data sets by arranging i·s pieces of data in order of data from the first data in units of i pieces and arranging the data sets in order of cycle.

The “bit reverse order” refers to an order related to the eight data sets Q0 to Q7 illustrated in FIG. 3. Each data set Qs(s=0, 1, . . . , 7) is composed of eight pieces of data from qs(0) to qs(7), where qs(i) is expressed by

qs(i)=s+8i

The data sets are arranged in an order of Q0, Q1, Q2, Q3, Q4, Q5, Q6, and Q7, according to progress of processing cycles. In other words, the bit reverse order refers to generating s data sets by arranging every eight pieces in is pieces of data input in the sequential order from the first data in units of i pieces and arranging i pieces of data in the same cycle as one set in order of data.

As described above, i-th data in data constituting a data set Qs (s=0, 1, . . . , 7) in the bit reverse order are s-th data of data constituting a data set Pi in the sequential order. Specifically, the following holds.

Qs(i)=Pi(s)

Thus, Qs(i) and Pi(s) have a relation in which an ordinal number of a data set is interchanged with an ordinal number of a data location in a data set with respect to data constituting each data set. Accordingly, rearranging, in the bit reverse order, data input in the bit reverse order results in data in the sequential order.

Each row ps(i) in FIG. 2 and each row qs(i) in FIG. 3 represents data input to i-th data in the next stage. Each of eight numbers included in each data set represents identification information for specifying one of FFT points and is specifically a value of the index n of x(n).

The sequential order and the bit reverse order are not limited to those illustrated in FIGS. 2 and 3. Specifically, each data set in the sequential order may be generated by sequentially arranging data according to the number of FFT points, the number of cycles, and the number of pieces of data processed in parallel, as described above. Then, each data set in the bit reverse order may be generated by interchanging an ordinal number based on progress of cycles with an ordinal number based on a data location with respect to data input in the sequential order, as described above.

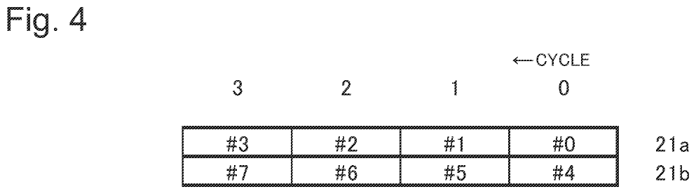

The first butterfly computation processing unit 21 is a butterfly circuit processing the butterfly computation processing 502 (first butterfly computation processing) in the first stage of the radix-8 butterfly computation processing performed in two stages in the dataflow 500 in FIG. 19. The first butterfly computation processing unit 21 includes two radix-8 butterfly computation processing units 21a and 21b and processes two sets of radix-8 butterfly computation processing in parallel. Specifically, the first butterfly computation processing unit 21 processes eight sets of radix-8 butterfly computation processing #0 to #7 constituting the butterfly computation processing 502 in an order illustrated in FIG. 4. Specifically, in a cycle 0, the radix-8 butterfly computation processing unit 21a inputs a data set Q0 being output in the bit reverse order by the first data sorting processing unit 11 and being related to the radix-8 butterfly computation processing #0 and performs the radix-8 butterfly computation processing #0. The radix-8 butterfly computation processing unit 21b inputs a data set Q4 being output in the bit reverse order by the first data sorting processing unit 11 and being related to the radix-8 butterfly computation processing #4 and performs the radix-8 butterfly computation processing #4.

In a cycle 1, the radix-8 butterfly computation processing unit 21a inputs a data set Q1 being output in the bit reverse order by the first data sorting processing unit 11 and being related to the radix-8 butterfly computation processing #1 and performs the radix-8 butterfly computation processing #1. The radix-8 butterfly computation processing unit 21b inputs a data set Q5 being output in the bit reverse order by the first data sorting processing unit 11 and being related to the radix-8 butterfly computation processing #5 and performs the radix-8 butterfly computation processing #5.

In a cycle 2, the radix-8 butterfly computation processing unit 21a inputs a data set Q2 being output in the bit reverse order by the first data sorting processing unit 11 and being related to the radix-8 butterfly computation processing #2 and performs the radix-8 butterfly computation processing #2. The radix-8 butterfly computation processing unit 21b inputs a data set Q6 being output in the bit reverse order by the first data sorting processing unit 11 and being related to the radix-8 butterfly computation processing #6 and performs the radix-8 butterfly computation processing #6.

In a cycle 3, the radix-8 butterfly computation processing unit 21a inputs a data set Q3 being output in the bit reverse order by the first data sorting processing unit 11 and being related to the radix-8 butterfly computation processing #3 and performs the radix-8 butterfly computation processing #3. The radix-8 butterfly computation processing unit 21b inputs a data set Q7 being output in the bit reverse order by the first data sorting processing unit 11 and being related to the radix-8 butterfly computation processing #7 and performs the radix-8 butterfly computation processing #7.

The first butterfly computation processing unit 21 outputs the results of the butterfly computation processing as data y(n) (n=0, 1, . . . , 63) in the sequential order in FIG. 2.

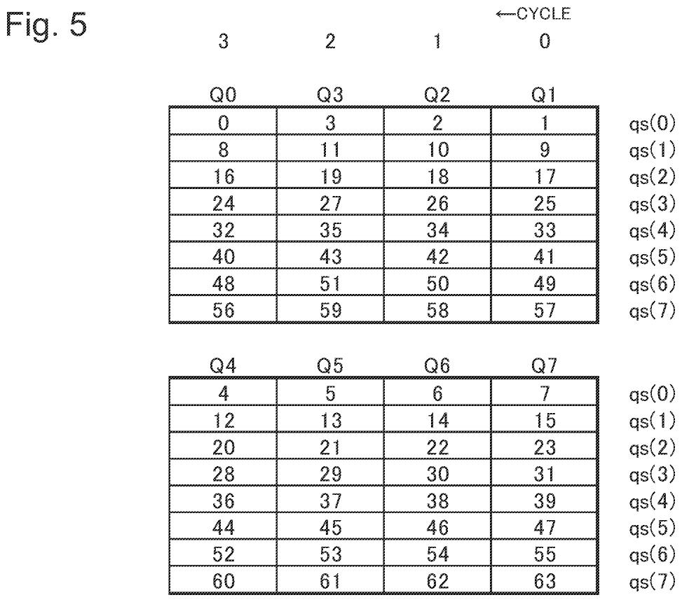

The second data sorting processing unit 12 rearranges, in an order illustrated in FIG. 5 (hereinafter an “optimized data set bit reverse order”), data y(n) output in the sequential order by the first butterfly computation processing unit 21. The “optimized data set bit reverse order” is related to an order when s data sets Q0 to Q(s−1) generated in the bit reverse order are output according to progress of cycles and can be specified by an output order setting 52. The optimized data set bit reverse order according to the present example embodiment is specified to be an order of {Q1, Q7}, {Q2, Q6}, {Q3, Q5}, and {Q0, Q4}, and the data sets Q1 and Q7, the data sets Q2 and Q6, the data sets Q3 and Q5, and the data sets Q0 and Q4 are output in a cycle 0, a cycle 1, a cycle 2, and a cycle 3, respectively.

The second data sorting processing unit 12 inputs the read address 51 output by the read address generation unit 41 and determines an output order.

The read address generation unit 41 refers to the output order setting 52 given from an upper-level circuit (unillustrated) such as a central processing unit (CPU) or the like and generates the read address 51 output to the second data sorting processing unit 12.

The twiddle multiplication processing unit 31 is a circuit processing a complex rotation on a complex plane in FFT computation after the first butterfly computation processing and is related to the twiddle multiplication processing 504 in the dataflow 500 in FIG. 19. Note that rearrangement of data is not performed in the twiddle multiplication processing.

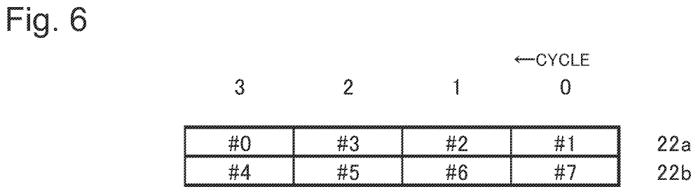

The second butterfly computation processing unit 22 is a butterfly circuit processing the butterfly computation processing 503 (second butterfly computation processing) in the second stage of the radix-8 butterfly computation processing performed in two stages in the dataflow 500 in FIG. 19. The second butterfly computation processing unit 22 includes two radix-8 butterfly computation processing units 22a and 22b and processes two sets of radix-8 butterfly computation processing in parallel. Specifically, the second butterfly computation processing unit 22 processes eight sets of radix-8 butterfly computation processing #0 to #7 constituting the butterfly computation processing 503 in an order illustrated in FIG. 6.

Specifically, in a cycle 0, the radix-8 butterfly computation processing unit 22a inputs a dataset Q1 being output in the optimized data set bit reverse order by the second data sorting processing unit 12 and being related to the radix-8 butterfly computation processing #1 and performs the radix-8 butterfly computation processing #1. The radix-8 butterfly computation processing unit 22b inputs a dataset Q7 being output in the optimized data set bit reverse order by the second data sorting processing unit 12 and being related to the radix-8 butterfly computation processing #7 and performs the radix-8 butterfly computation processing #7.

In a cycle 1, the radix-8 butterfly computation processing unit 22a inputs a dataset Q2 being output in the optimized data set bit reverse order by the second data sorting processing unit 12 and being related to the radix-8 butterfly computation processing #2 and performs the radix-8 butterfly computation processing #2. The radix-8 butterfly computation processing unit 22b inputs a dataset Q6 being output in the optimized data set bit reverse order by the second data sorting processing unit 12 and being related to the radix-8 butterfly computation processing #6 and performs the radix-8 butterfly computation processing #6.

In a cycle 2, the radix-8 butterfly computation processing unit 22a inputs a dataset Q3 being output in the optimized data set bit reverse order by the second data sorting processing unit 12 and being related to the radix-8 butterfly computation processing #3 and performs the radix-8 butterfly computation processing #3. The radix-8 butterfly computation processing unit 22b inputs a dataset Q5 being output in the optimized data set bit reverse order by the second data sorting processing unit 12 and being related to the radix-8 butterfly computation processing #5 and performs the radix-8 butterfly computation processing #5.

In a cycle 3, the radix-8 butterfly computation processing unit 22a inputs a dataset Q0 being output in the optimized data set bit reverse order by the second data sorting processing unit 12 and being related to the radix-8 butterfly computation processing #0 and performs the radix-8 butterfly computation processing #0. The radix-8 butterfly computation processing unit 22b inputs a dataset Q4 being output in the optimized data set bit reverse order by the second data sorting processing unit 12 and being related to the radix-8 butterfly computation processing #4 and performs the radix-8 butterfly computation processing #4.

The second butterfly computation processing unit 22 outputs the butterfly computation processing results X(k) (n=0, 1, . . . , 63) similarly in the optimized data set bit reverse order.

The first data sorting processing unit 11 and the second data sorting processing unit 12 implement data sorting processing in accordance with the bit reverse order in FIG. 3 and the optimized data set sequential order in FIG. 5, respectively, by temporarily storing input data and controlling selection and output of the stored data. Specific examples of a data sorting processing unit will be described below.

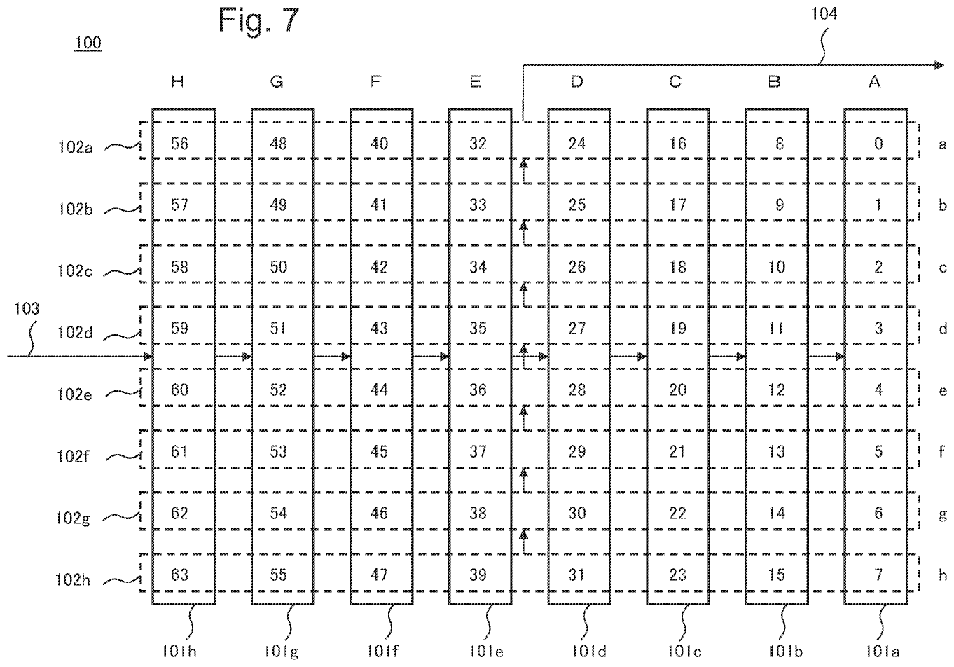

For example, the first data sorting processing unit 11 can be implemented by a data sorting processing unit 100 illustrated in FIG. 7.

The data sorting processing unit 100 inputs data sets D1 to D8 input as input information 103, each data set being composed of eight pieces of data, in units of two data sets in a first-in order in a first in first out buffer (FIFO buffer), and stores the data by writing the data into data storage locations 101a to 101h. Specifically, the data sets D1 to D8 are stored in the data storage locations 101a to 101h, respectively. The data storage locations 101a to 101h are an example of a first storage means.

Next, the data sorting processing unit 100 outputs stored data in a first-out order in a FIFO buffer in units of two data sets. Specifically, the data sorting processing unit 100 reads eight pieces of data from the data read locations 102a to 102h to form one data set and outputs eight data sets D1′ to D8′ as output information 104. Thus, the data sets D1′ to D8′ are acquired by rearranging, in order of data location, data included in the data sets D1 to D8 arranged in order of cycle as one set.

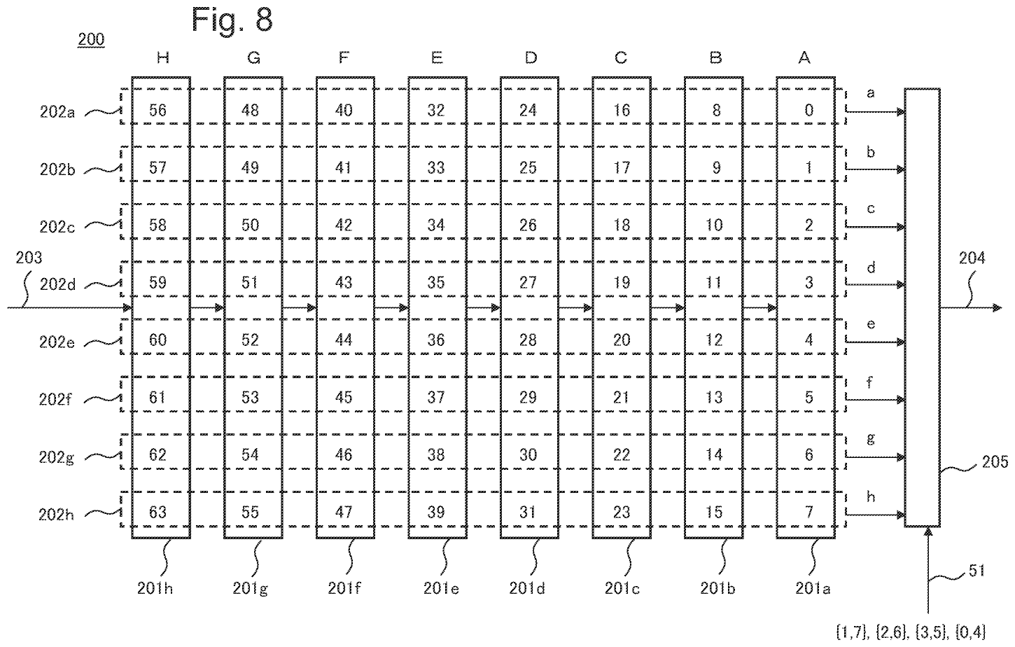

On the other hands, FIG. 8 is a configuration diagram of a data sorting processing unit 200 representing an implementation example of the second data sorting processing unit 12. The data sorting processing unit 200 inputs data sets P1 to P8 input as input information 203, each data set being composed of eight pieces of data, in units of two data sets in the first-in order in a FIFO buffer and stores the data by writing the data into data storage locations 201a to 201h. Specifically, the data sets D1 to D8 are sequentially stored into the data storage locations 201a to 201h related to the order of cycle, respectively. At this time, when the stored data are viewed in order of data location, in other words, in an order of data storage locations 202a to 202h, the data sets D1′ to D8′ are stored in the data storage locations 202a to 202h, respectively.

Next, the data sorting processing unit 200 reads the stored data by a reading circuit 205 in units of two data sets and outputs the data as output information 204. At this time, the reading circuit 205 refers to the read address 51, selects two locations out of the data storage locations 202a to 202h, and reads two sets of eight pieces of data stored in the data storage locations 202a to 202h by a single reading operation. Thus, by giving the read address 51 read addresses in a desired combination and a desired order that can be freely specified, data can be read in any combination and any order. For example, when read addresses are given to the read address 51 in a combination and an order of addresses {1, 7}, {2, 6}, {3, 5}, and {0, 4}, the data sorting processing unit 200 outputs the stored data in an order of the data sets {D1′, D7′}, {D2′, D6′}, {D3′, D5′}, and {D0′, D4′}. In other words, the data are output in the optimized data set sequential order illustrated in FIG. 5. The data sets D1′ to D8′ are acquired by rearranging, in order of data location, the data included in the data sets D1 to D8 arranged in order of cycle as one set.

As described above, two rounds of sorting processing are performed in accordance with the sequential order in FIG. 2, the bit reverse order in FIG. 3, and the any data set sequential order in FIG. 5 by the first data sorting processing unit 11 and the second data sorting processing unit 12, respectively, in the FFT device 10.

By controlling each of the first data sorting processing unit 11 and the second data sorting processing unit 12 as described above, the processing orders of the radix-8 butterfly computation processing processed by the first butterfly computation processing unit 21 and the second butterfly computation processing unit 22 can be controlled to be the orders illustrated in FIG. 4 and FIG. 6, respectively. Consequently, a plurality of pieces of data required for processing in a next stage can be output at the same timing, and therefore further rearrangement of data is not required. Rearrangement of data in the second data sorting processing unit 12 and the processing order in the second butterfly computation processing unit 22 will be described below as an example.

A case of performing 64-point FFT processing in 16-data parallel by using the FFT device 10 illustrated in FIG. 1 will be described as an example. The FFT device 10 inputs time-domain data x(n) (n=0, 1, . . . , 63), generates frequency-domain signals X(k) (k=0, 1, . . . , 63) Fourier-transformed by FFT processing, and outputs X(k). The input data x(n) are input in the order illustrated in FIG. 2 in a period of four cycles in units of 16 pieces of data, and 64 pieces of data x(n) in total are input. Note that FIG. 2 only indicates the index n of x(n).

Specifically, 16 pieces of data in total including eight pieces of data x(0), x(1), . . . , and x(7) constituting a data set P0 and eight pieces of data x(8), x(9), . . . , and x(15) constituting a data set P1 are input in a first cycle. Then, 16 pieces of data in total including eight pieces of data x(16), x(17), . . . , and x(23) constituting a data set P2 and eight pieces of data x(24), x(25), . . . , and x(31) constituting a data set P3 are input in a first cycle. From there onward, data constituting data sets P4 to P7 are similarly input in a second cycle and a third cycle.

On the other hands, with respect to output data X(k), 64 pieces of data in total are output in, for example, the order illustrated in FIG. 5 in a period of four cycles in units of 16 pieces of data. Note that FIG. 5 only indicates an index k of X(k). Specifically, the following data are output in each cycle.

### Cycle 0:

Eight pieces of data X(1), X(9), . . . , and X(57) constituting a data set Q1 and

eight pieces of data X(7), X(15), . . . , and X(63) constituting a data set Q7 are output.

### Cycle 1:

Eight pieces of data X(2), X(10), . . . , and X(58) constituting a data set Q2 and

eight pieces of data X(6), X(14), . . . , and X(62) constituting a data set Q6 are output.

### Cycle 2:

Eight pieces of data X(3), X(11), . . . , and X(59) constituting a data set Q3 and

eight pieces of data X(5), X(13), . . . , and X(61) constituting a data set Q5 are output.

### Cycle 3:

Eight pieces of data X(0), X(8), . . . , and X(56) constituting a data set Q0 and

eight pieces of data X(4), X(12), . . . , and X(60) constituting a data set Q4 are output.

Thus, two pieces of output data X1(k1) and X2(k2) the sum of the respective indices k1 and k2 of which is equal to 64 corresponding to the number of FFT points are always output in the same cycle. In other words, the FFT device 10 can always output outputs X(k) and X(N−k) (N=64) in the same cycle for any value of the index k being equal to or greater than 1 and equal to or less than N−1.

### Advantageous Effect of First Example Embodiment

As described above, the FFT device 10 according to the present example embodiment can output data in any order by specifying the order by using the output order setting 52.

For example, with respect to output data X(k) (k=0, 1, . . . , N−1), when a computation is performed between a plurality of pieces of X(k) with different values of k in a stage subsequent to the FFT device 10, two pieces of X(k) being input values to the computation can be output in the same cycle or in cycles as close to each other as possible. When a computation is performed between X(k) and X(N−k) for any value of the index k being equal to or greater than 1 and equal to or less than N−1, X(k) and X(N−k) can be output in the same cycle. Consequently, addition of a circuit for newly rearranging outputs is not required.

Further, the read address generation unit 41 is the only circuit to be added for enabling specification of an order in which output data are output, and the circuit scale of the unit is very small.

Accordingly, increase in processing latency, a circuit scale, and power consumption as a whole including processing in the subsequent stage can be suppressed.

While FFT processing has been described in the present example embodiment as an example, the same holds for IFFT. Specifically, optimization of an output order of processing results in consideration of processing in a stage subsequent to IFFT processing by applying the control method according to the present example embodiment to an IFFT processing device enables speedup of the processing in the stage subsequent to the IFFT processing.

### Second Example Embodiment

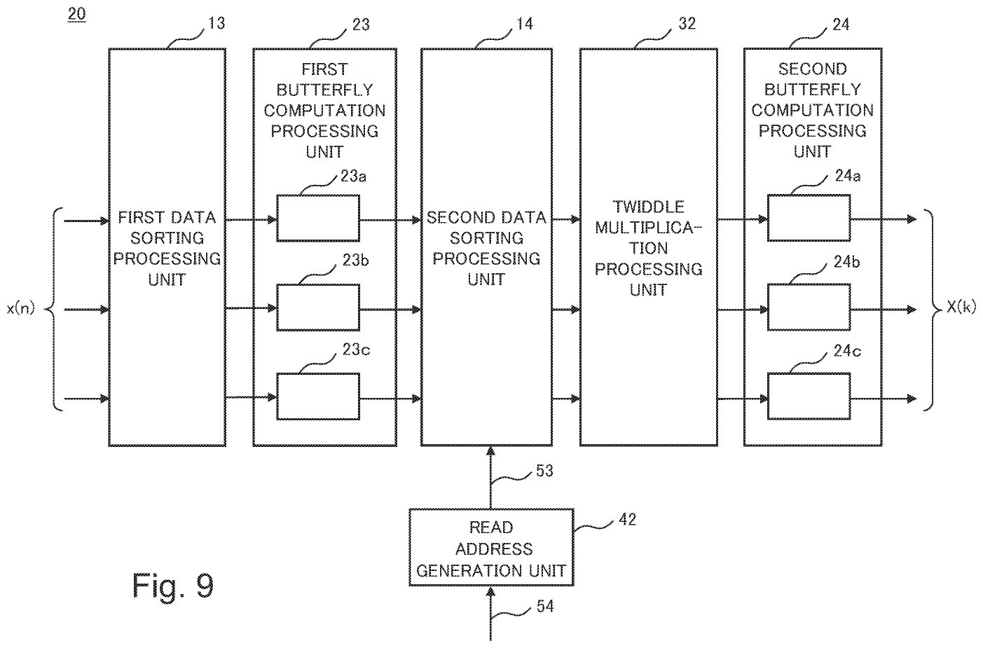

FIG. 9 is a block diagram illustrating a configuration example of an FFT device 20 according to a second example embodiment of the present invention. Similarly to the FFT device 10 according to the first example embodiment, the FFT device 20 processes a 64-point FFT decomposed into two stages of radix-8 butterfly processing in accordance with the dataflow 500 illustrated in FIG. 19 by the pipeline circuit method. While the FFT device 10 according to the first example embodiment performs 64-point FFT processing in 16-data parallel, it is assumed that the FFT device 20 according to the present example embodiment performs 64-point FFT processing in 24-data parallel.

The FFT device 20 inputs time-domain data x(n) (n=0, 1, . . . , N−1), generates frequency-domain signals X(k) (k=0, 1, . . . , N−1) by Fourier-transforming x(n) by FFT processing, and outputs X(k). Note that N is a positive integer denoting an FFT block size.

The FFT device 20 includes a first data sorting processing unit 13 and a first butterfly computation processing unit 23 as an example of a first transform means, a second data sorting processing unit 14 as an example of a first data sorting processing means, a twiddle multiplication processing unit 32, a second butterfly computation processing unit 24, and a read address generation unit 42. The FFT device 20 performs pipeline processing on first data sorting processing, first butterfly computation processing, second data sorting processing, twiddle multiplication processing, and second butterfly computation processing.

The first data sorting processing unit 13 and the second data sorting processing unit 14 are buffer circuit for data rearrangement. The first data sorting processing unit 13 performs rearrangement of a data sequence based on data dependency in an FFT processing algorithm, before the first butterfly computation processing unit 23. Similarly, the second data sorting processing unit 14 inputs a read address 53 and performs rearrangement of a data sequence based on data dependency in the FFT processing algorithm, after the first butterfly computation processing unit 23. Furthermore, with respect to the output X(k) of the FFT device 20, the second data sorting processing unit 14 performs sorting processing for outputting outputs X(k) and X(N−k) in the same cycle for any k being equal to or greater than 1 and equal to or less than N−1, in addition to the aforementioned rearrangement.

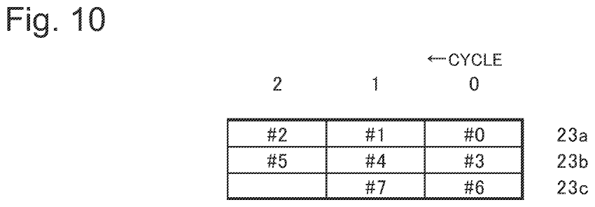

The first butterfly computation processing unit 23 is a butterfly circuit processing the butterfly computation processing 502 (first butterfly computation processing) in the first stage of the radix-8 butterfly computation processing performed in two stages in the dataflow 500 in FIG. 19. The first butterfly computation processing unit 23 includes three radix-8 butterfly computation processing units 23a, 23b, and 23c and processes three sets of radix-8 butterfly computation processing in parallel. Specifically, the first butterfly computation processing unit 23 processes eight sets of radix-8 butterfly computation processing #0 to #7 constituting the butterfly computation processing 502 in an order illustrated in FIG. 10.

Specifically, in a cycle 0, the radix-8 butterfly computation processing unit 23a performs the radix-8 butterfly computation processing #0. The radix-8 butterfly computation processing unit 23b performs the radix-8 butterfly computation processing #3. The radix-8 butterfly computation processing unit 23c performs the radix-8 butterfly computation processing #6.

In a cycle 1, the radix-8 butterfly computation processing unit 23a performs the radix-8 butterfly computation processing #1. The radix-8 butterfly computation processing unit 23b performs the radix-8 butterfly computation processing #4. The radix-8 butterfly computation processing unit 23c performs the radix-8 butterfly computation processing #7.

In a cycle 2, the radix-8 butterfly computation processing unit 23a performs the radix-8 butterfly computation processing #2. The radix-8 butterfly computation processing unit 23b performs the radix-8 butterfly computation processing #5. The radix-8 butterfly computation processing unit 23c does not perform processing.

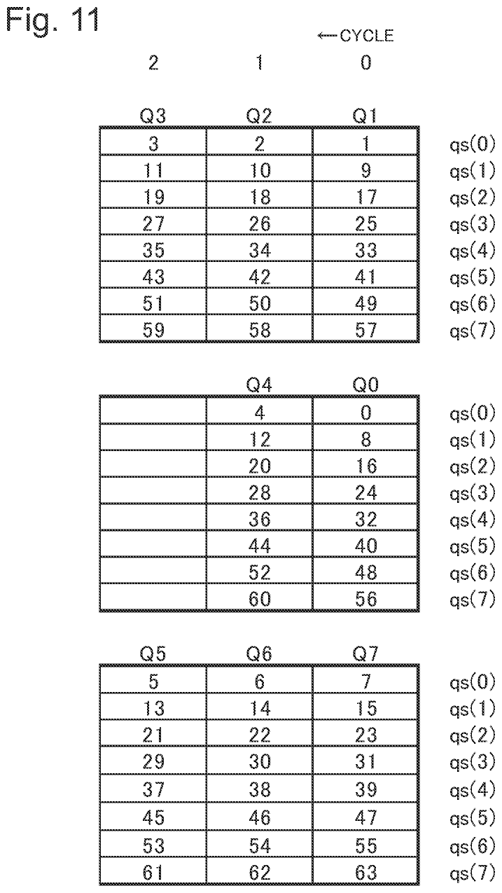

The second data sorting processing unit 14 rearranges, in an optimized data set bit reverse order illustrated in FIG. 11, data y(n) output in the sequential order by the first butterfly computation processing unit 23. The optimized data set bit reverse order according to the present example embodiment is specified to be an order of {Q1, Q0, Q7}, {Q2, Q4, Q6}, and {Q3, Q5}, and data sets Q1, Q0, and Q7, data sets Q2, Q4, and Q6, and data sets Q3 and Q5 are output in a cycle 0, a cycle 1, and a cycle 2, respectively.

The twiddle multiplication processing unit 32 is a circuit processing a complex rotation on a complex plane in FFT computation after the first butterfly computation processing and is related to the twiddle multiplication processing 504 in the dataflow 500 in FIG. 19. Note that rearrangement of data is not performed in the twiddle multiplication processing.

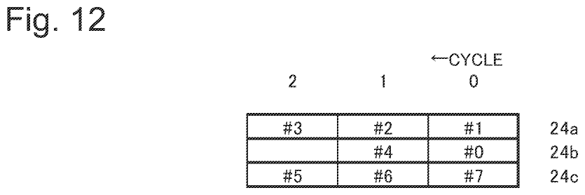

The second butterfly computation processing unit 24 is a butterfly circuit processing the butterfly computation processing 503 (second butterfly computation processing) in the second stage of the radix-8 butterfly computation processing performed in two stages in the dataflow 500 in FIG. 19. The second butterfly computation processing unit 24 includes three radix-8 butterfly computation processing units 24a, 24b, and 24c and processes three sets of radix-8 butterfly computation processing in parallel. Specifically, the second butterfly computation processing unit 24 processes eight sets of radix-8 butterfly computation processing #0 to #7 constituting the butterfly computation processing 503 in an order illustrated in FIG. 12.

Specifically, in a cycle 0, the radix-8 butterfly computation processing unit 24a inputs a dataset Q1 being output in the optimized data set bit reverse order by the second data sorting processing unit 14 and being related to the radix-8 butterfly computation processing #1 and performs the radix-8 butterfly computation processing #1. The radix-8 butterfly computation processing unit 24b inputs a dataset Q0 being output in the optimized data set bit reverse order by the second data sorting processing unit 14 and being related to the radix-8 butterfly computation processing #0 and performs the radix-8 butterfly computation processing #0. The radix-8 butterfly computation processing unit 24c inputs a dataset Q7 being output in the optimized data set bit reverse order by the second data sorting processing unit 14 and being related to the radix-8 butterfly computation processing #7 and performs the radix-8 butterfly computation processing #7.

In a cycle 1, the radix-8 butterfly computation processing unit 24a inputs a dataset Q2 being output in the optimized data set bit reverse order by the second data sorting processing unit 14 and being related to the radix-8 butterfly computation processing #2 and performs the radix-8 butterfly computation processing #2. The radix-8 butterfly computation processing unit 24b inputs a dataset Q4 being output in the optimized data set bit reverse order by the second data sorting processing unit 14 and being related to the radix-8 butterfly computation processing #4 and performs the radix-8 butterfly computation processing #4. The radix-8 butterfly computation processing unit 24c inputs a dataset Q6 being output in the optimized data set bit reverse order by the second data sorting processing unit 14 and being related to the radix-8 butterfly computation processing #6 and performs the radix-8 butterfly computation processing #6.

In a cycle 2, the radix-8 butterfly computation processing unit 24a inputs a dataset Q3 being output in the optimized data set bit reverse order by the second data sorting processing unit 14 and being related to the radix-8 butterfly computation processing #3 and performs the radix-8 butterfly computation processing #3. The radix-8 butterfly computation processing unit 24b does not perform processing. The radix-8 butterfly computation processing unit 24c inputs a dataset Q5 being output in the optimized data set bit reverse order by the second data sorting processing unit 14 and being related to the radix-8 butterfly computation processing #5 and performs the radix-8 butterfly computation processing #5.

As described above, the FFT device 10 processes the 64-point FFT processing in four cycles by performing the processing in 16-data parallel, whereas the FFT device 20 performs processing in 24-data parallel and therefore can speed up the 64-point FFT processing to be performed in three cycles.

Further, by controlling each of the first data sorting processing unit 13 and the second data sorting processing unit 14 as described above, the FFT device 20 can control the processing orders of sets of the radix-8 butterfly computation processing processed by the first butterfly computation processing unit 23 and the second butterfly computation processing unit 24 to be orders illustrated in FIG. 10 and FIG. 12, respectively. Consequently, a plurality of pieces of data required for processing in a next stage can be output at the same timing, and therefore further rearrangement of data is not required. Rearrangement of data in the second data sorting processing unit 14 and the processing order in the second butterfly computation processing unit 24 will be described below as an example.

A case of performing 64-point FFT processing in 24-data parallel by using the FFT device 20 illustrated in FIG. 9 will be described as an example. The FFT device 20 inputs time-domain data x(n) (n=0, 1, . . . , 63), generates frequency-domain signals X(k) (k=0, 1, . . . , 63) Fourier-transformed by FFT processing, and outputs X(k). The input data x(n) are input in the sequential order in a period of three cycles in units of 24 pieces of data, and 64 pieces of data x(n) in total are input.

Specifically, 24 pieces of data in total including eight pieces of data x(0), x(1), . . . , and x(7) constituting a data set P1, eight pieces of data x(8), x(9), . . . , and x(15) constituting a data set P1, and eight pieces of data x(16), x(17), . . . , and x(23) constituting a data set P2 are input in a first cycle. Then, 24 pieces of data in total including eight pieces of data x(24), x(25), . . . , and x(31) constituting a data set P3, eight pieces of data x(32), x(33), . . . , and x(39) constituting a data set P4, and eight pieces of data x(40), x(41), . . . , and x(47) constituting a data set P5 are input in a first cycle. Similarly, 16 pieces of data in total including eight pieces of data x(48), x(49), . . . , and x(55) constituting a data set P6 and eight pieces of data x(56), x(57), . . . , and x(63) constituting a data set P7 are input in a second cycle.

On the other hands, with respect to the output data X(k), 64 pieces of data in total are output in, for example, the order illustrated in FIG. 11 in a period of three cycles in units of 24 pieces of data. Note that FIG. 11 only indicates an index k of X(k). Specifically, the following data are output in each cycle.

### Cycle 0:

Eight pieces of data X(1), X(9), . . . , and X(57) constituting the data set Q1,

eight pieces of data X(0), X(8), . . . , and X(56) constituting the data set Q0, and

eight pieces of data X(7), X(15), . . . , and X(63) constituting the data set Q7 are output.

### Cycle 1:

Eight pieces of data X(2), X(10), . . . , and X(58) constituting the data set Q2,

eight pieces of data X(4), X(12), . . . , and X(60) constituting the data set Q4, and

eight pieces of data X(6), X(14), . . . , and X(62) constituting the data set Q6 are output.

### Cycle 2:

Eight pieces of data X(3), X(11), . . . , and X(59) constituting the data set Q3 and

eight pieces of data X(5), X(13), . . . , and X(61) constituting the data set Q5 are output.

Thus, two pieces of output data X1(k1) and X2(k2) the sum of the respective indices k1 and k2 of which is equal to 64 corresponding to the number of FFT points are always output in the same cycle. In other words, the FFT device 10 can always output outputs X(k) and X(N−k) (N=64) in the same cycle for any value of the index k being equal to or greater than 1 and equal to or less than N−1.

### Advantageous Effect of Second Example Embodiment

As described above, the FFT device 20 according to the present example embodiment can output data in any order by specifying the order by using an output order setting 54.

For example, with respect to output data X(k) (k=0, 1, . . . , N−1), when a computation is performed between a plurality of pieces of X(k) with different values of k in a stage subsequent to the FFT device 20, two pieces of X(k) being input values to the computation can be output in the same cycle or in cycles as close to each other as possible. When a computation is performed between X(k) and X(N−k) for any value of the index k being equal to or greater than 1 and equal to or less than N−1, X(k) and X(N−k) can be output in the same cycle. Consequently, addition of a circuit for newly rearranging outputs is not required.

Further, the read address generation unit 42 is the only circuit to be added for enabling specification of an order in which output data are output, and the circuit scale of the unit is very small.

Accordingly, increase in processing latency, a circuit scale, and power consumption as a whole including processing in the subsequent stage can be suppressed.

While FFT processing has been described in the present example embodiment as an example, the same holds for IFFT. Specifically, optimization of an output order of processing results in consideration of processing in a stage subsequent to IFFT processing by applying the control method according to the present example embodiment to an IFFT processing device enables speedup of the processing in the stage subsequent to the IFFT processing.

### Third Example Embodiment

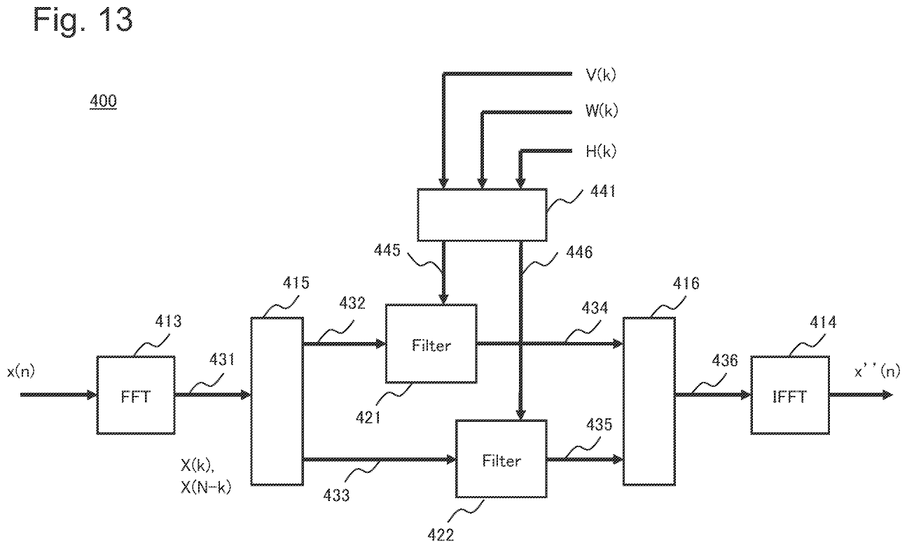

FIG. 13 is a block diagram illustrating a configuration of a digital filter circuit 400 according to a third example embodiment of the present invention. The digital filter circuit 400 includes an FFT circuit 413, an IFFT circuit 414, a complex conjugate generation circuit 415, a complex conjugate synthesis circuit 416, a filter circuit 421, a filter circuit 422, and a filter coefficient generation circuit 441.

The digital filter circuit 400 inputs a time-domain complex signal as follows.

x(n)=r(n)+js(n) (1)

The FFT circuit 413 transforms the input complex signal x(n) into a frequency-domain complex signal 431 by an FFT as follows.

X(k)=A(k)+jB(k) (2)

Note that n is an integer denoting a time-domain signal sample number and satisfying 0≤n≤N−1, N is an integer denoting the number of FFT transform samples and satisfying 0<N, and k is an integer denoting a frequency-domain frequency number and satisfying 0≤k≤N−1.

Further, the FFT circuit 413 generates the following signal from X(k) and outputs the signal.

X(N−k)=A(N−k)+jB(N−k) (3)

For each frequency number k satisfying 0≤k≤N−1, the complex conjugate generation circuit 415 inputs X(N−k) output by the FFT circuit 413 and generates a complex conjugate of X(N−k) as follows.

X*(N−k)=A(N−k)−jB(N−k) (4)

The complex conjugate generation circuit 415 outputs the input complex signal X(k) as a complex signal 432 and outputs the generated complex signal X*(N−k) as a complex signal 433.

Next, for each frequency number k satisfying 0≤k≤N−1, the filter coefficient generation circuit 441 generates a complex coefficient

C1(k)={V(k)+W(k)}×H(k) (5)

and a complex coefficient

C2(k)={V(k)−W(k)}×H(k) (6)

from input complex coefficients V(k), W(k), and H(k).

The complex coefficients V(k), W(k), and H(k) are frequency-domain coefficients given by an upper-level circuit (unillustrated) of the digital filter circuit 400 and correspond to real filter coefficients when filter processing by time-domain real computation is performed. Details of V(k), W(k), and H(k) will be described later.

The filter coefficient generation circuit 441 outputs the generated complex coefficient C1(k) as a complex signal 445. Further, the filter coefficient generation circuit 441 generates a complex signal C2 (N−k) from the complex signal C2(k) [formula (6)] and outputs C2 (N−k) as a complex signal 446.

Next, the filter circuit 421 performs complex filter processing by complex multiplication on X(k) [formula (2)] output to the complex signal 432 by the complex conjugate generation circuit 415 by using C1(k) [formula (5)] output to the complex signal 445 by the filter coefficient generation circuit 441. Specifically, for each frequency number k satisfying 0≤k≤N−1, the filter circuit 421 computes a complex signal

X′(k)=X(k)×C1(k) (7)

and outputs X′(k) as a complex signal 434.

Similarly, the filter circuit 422 performs complex filter processing by complex multiplication on X*(N−k) [formula (4)] output to the complex signal 433 by the complex conjugate generation circuit 415 by using C2(N−k) [formula (6)] output to the complex signal 446 by the filter coefficient generation circuit 441. Specifically, for each frequency number k satisfying 0≤k≤N−1, the filter circuit 422 computes a complex signal

X*′(N−k)=X*(N−k)×C2(N−k) (8)

and outputs X*′(N−k) as a complex signal 435.

Each of C1(k) and C2(k) can be separated into a real part and an imaginary part and be expressed as follows.

C1(k)=C1I(k)+jC1Q(k) (9)

C2(k)=C2I(k)+jC2Q(k) (10)

Next, the complex conjugate synthesis circuit 416 generates a complex signal X″(k) synthesized from X′(k) [formula (7)] output to the complex signal 434 by the filter circuit 421 and X*′(N−k) [formula (8)] output to the complex signal 435 by the filter circuit 422. Specifically, for each frequency number k satisfying 0≤k≤N−1, the complex conjugate synthesis circuit 416 computes

X″(k)=½×{X′(k)+X′(N−k)} (11)

and outputs X″(k) as a complex signal 436.

Next, for each frequency number k satisfying 0≤k≤N−1, the IFFT circuit 414 generates a time-domain complex signal x″(n) by an IFFT from X″(k) [formula (11)] output to the complex signal 436 by the complex conjugate synthesis circuit 416 and outputs x″(n).

The FFT device 10 according to the first example embodiment of the present invention may be used as a method for implementing the FFT circuit 413. Alternatively, the FFT device 20 according to the second example embodiment of the present invention may be used as the method for implementing the FFT circuit 413.

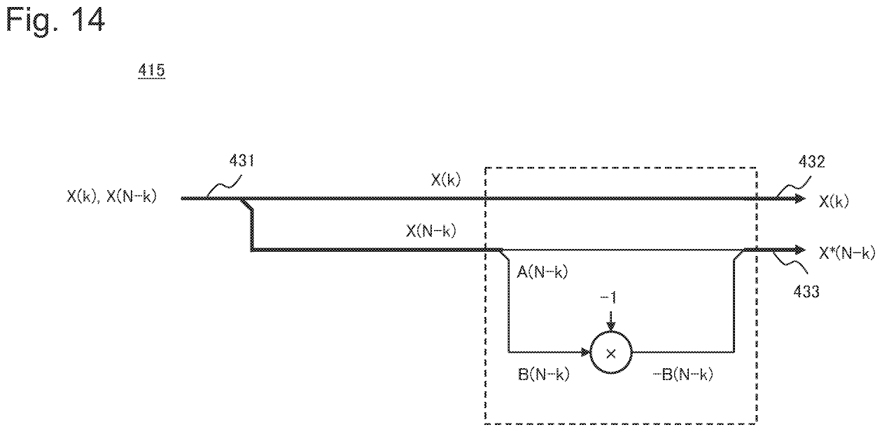

FIG. 14 is a block diagram illustrating a detailed configuration of the complex conjugate generation circuit 415. The complex conjugate generation circuit 415 inputs X(k) [=A(k)+jB(k): formula (2)] included in the output of the FFT circuit 413 and outputs X(k) as-is. Furthermore, the complex conjugate generation circuit 415 inputs the output X(N−k)[=A(N−k)+jB(N−k): formula (3)] included in the output of the FFT circuit 413, and computes and outputs

X*(N−k)=A(N−k)−jB(N−k) (4)

Each of X(k) and X*(N−k) can be separated into a real part and an imaginary part and be expressed as follows.

X(k)=XI(k)+jXQ(k) (12)

X*(N−k)=X*I(N−k)+jX*Q(N−k) (13)

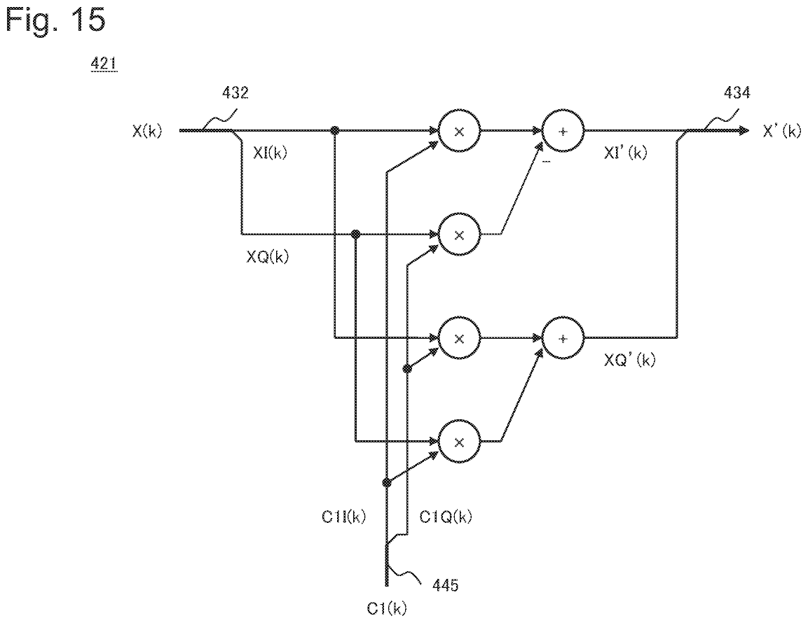

FIG. 15 is a block diagram illustrating a detailed configuration of the filter circuit 421. The filter circuit 421 inputs X(k) [=XI(k)+jXQ(k): formula (12)] output to the complex signal 432 by the complex conjugate generation circuit 415 and the complex coefficient C1(k) [=C1I(k)+jC1Q(k): formula (9)], and computes and outputs

$${X}^{′} ( k ) = {XI}^{′} ( k ) + {jXQ}^{′} ( k ) \qquad ( 14 )$$

$$= X ( k ) \times C 1 ( k )$$

XI′(k) and XQ′(k) are the real part and the imaginary part of X′(k), respectively, and are given by the following equations.

XI′(k)=XI(k)×C1I(k)−XQ(k)×C1Q(k) (15)

XQ′(k)=XI(k)×C1Q(k)+XQ(k)×C1I(k) (16)

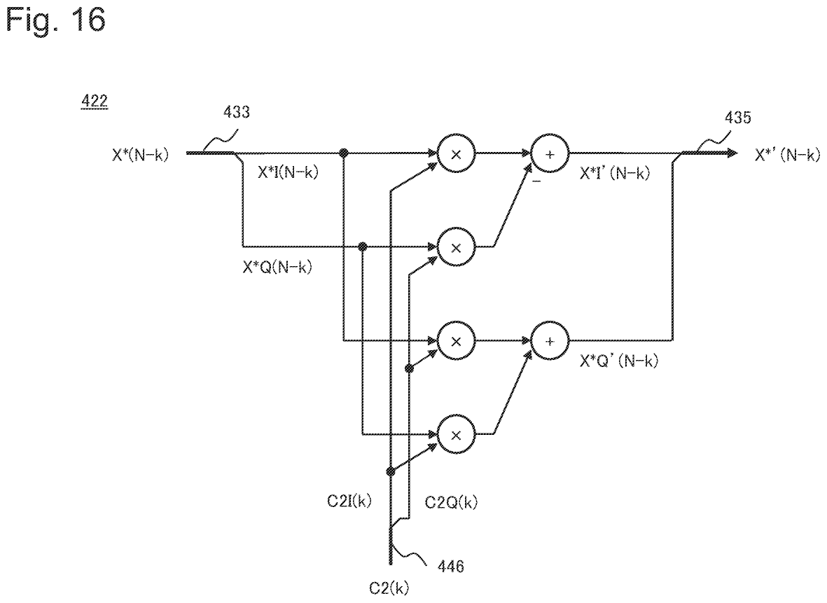

FIG. 16 is a block diagram illustrating a detailed configuration of the filter circuit 422. The filter circuit 422 inputs X*(N−k) [=X*I(N−k)+jX*Q(N−k): formula (13)] output to the complex signal 433 by the complex conjugate generation circuit 415 and the complex coefficient C2(k) [=C2I(k)+jC2Q(k): formula (10)], and computes and outputs

$${X}^{* ′} ( N - k ) = {X}^{*} {I}^{′} ( N - k ) + {jX}^{*} {Q}^{′} ( N - k ) \qquad ( 17 )$$

$$= {X}^{*} ( N - k ) \times C 2 ( N - k )$$

X*I′(N−k) and X*Q′(N−k) are the real part and the imaginary part of X″(N−k), respectively, and are given by the following equations.

X*I′(N−k)=X*I(N−k)×C2I(N−k)−X*Q(N−k)×C2Q(N−k) (18)

X*Q′(N−k)=X*I(N−k)×C2Q(N−k)+X*Q(N−k)×C2I(N−k) (19)

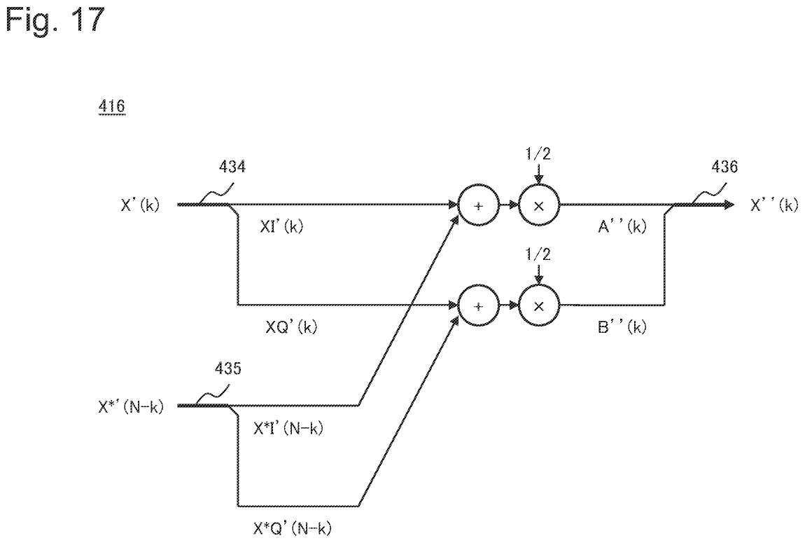

FIG. 17 is a block diagram illustrating a detailed configuration of the complex conjugate synthesis circuit 416. For each frequency number k satisfying 0≤k≤N−1, the complex conjugate synthesis circuit 416 inputs X′(k) [=XI′(k)+jXQ′(k): formula (14)] output to the complex signal 434 by the filter circuit 421 and X*′(N−k) [=X*I′(N−k)+jX*Q′(N−k): formula (17)] output to the complex signal 435 by the filter circuit 422, and computes and outputs

$${X}^{″} ( k ) = {XI}^{″} ( k ) + {jXQ}^{″} ( k ) \qquad ( 20 )$$

$$= 1 / 2 \{ {X}^{′} ( k ) + {X}^{* ′} ( N - k ) \}$$

XI″(k) and XQ″(k) are the real part and the imaginary part of X″(k), respectively, and are given by the following equations.

XI″(k)=½{XI′(k)+X*I′(N−k)} (21)

XQ″(k)=½{XQ′(k)+X*Q′(N−k)} (22)

Note that XI′(k), XQ′(k), X*I′(N−k), and X*Q′(N−k) are expressed by equations (15), (16), (18), and (19), respectively.

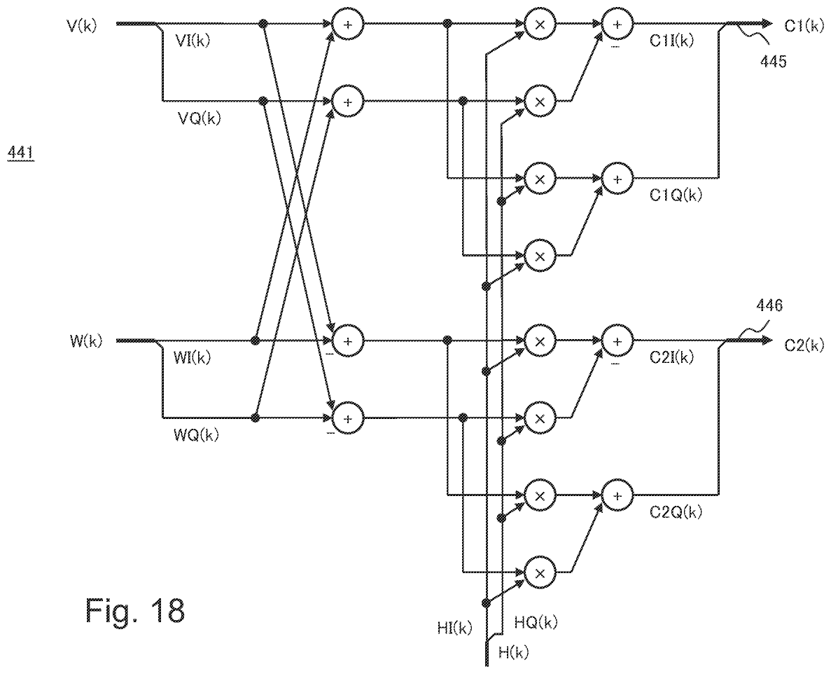

The filter coefficient generation circuit 441 generates the complex coefficients C1(k) and C2(k) used in the filter circuits 421 and 422. FIG. 18 is a block diagram illustrating a detailed configuration of the filter coefficient generation circuit 441. For each frequency number k satisfying 0≤k≤N−1, the filter coefficient generation circuit 441 computes V(k)+W(k) and V(k)−W(k) from the complex coefficients V(k) and W(k) input from the upper-level circuit (unillustrated).

Note that the following equations hold.

V(k)+W(k)=VI(k)+WI(k)+jVQ(k)+jWQ(k) (23)

V(k)−W(k)=VI(k)−WI(k)+jVQ(k)−jWQ(k) (24)

VI(k) and VQ(k) are the real part and the imaginary part of V(k), respectively, and WI(k) and WQ(k) are the real part and the imaginary part of W(k), respectively.

Further, H(k) can be separated into a real part and an imaginary part and be expressed as follows.

H(k)=HI(k)+jHQ(k) (25)

Next, the filter coefficient generation circuit 441 computes and outputs the complex coefficients C1(k) and C2(k) defined by the following equations.

$$C 1 ( k ) = C 1 I ( k ) + jC 1 Q ( k ) \qquad ( 26 )$$

$$= \{ V ( k ) + W ( k ) \} \times H ( k )$$

$$C 2 ( k ) = C 2 I ( k ) + jC 2 Q ( k ) \qquad ( 27 )$$

$$= \{ V ( k ) - W ( k ) \} \times H ( k )$$

C1I(k) and C1Q(k) are the real part and the imaginary part of C1(k), respectively, and C2I(k) and C2Q(k) are the real part and the imaginary part of C2(k), respectively.

Substitution of equations (23) and (25) into formula (26) yields

C1(k)={VI(k)+WI(k)+jVQ(k)+jWQ(k)}×{HI(k)+jHQ(k)} (28)

Accordingly,

C1I(k)={VI(k)+WI(k)}×HI(k)−{VQ(k)+WQ(k)}×HQ(k) (29)

C1Q(k)={VQ(k)+WQ(k)}×HI(k)+{VI(k)+WI(k)}×HQ(k) (30)

Similarly, substitution of equations (24) and (25) into formula (27) yields

$$C 2 ( k ) = C 2 I ( k ) + jC 2 Q ( k ) \qquad ( 31 )$$

$$= \{ V ( k ) - W ( k ) \} \times H ( k )$$

$$= \{ VI ( k ) - WI ( k ) + jVQ ( k ) - jWQ ( k ) \} \times \{ HI ( k ) + jHQ ( k ) \}$$

Accordingly,

C2I(k)={VI(k)−WI(k)}×HI(k)−{VQ(k)−WQ(k)}×HQ(k) (32)

C2Q(k)={VQ(k)−WQ(k)}×HI(k)+{VI(k)−WI(k)}×HQ(k) (33)

As described above, the digital filter circuit 400 generates a frequency-domain complex signal by FFT-transforming a time-domain input signal. Then, the digital filter circuit 400 independently performs filter processing on each of the real part and the imaginary part of the frequency-domain complex signal by using two types of coefficients generated from V(k), W(k), and H(k) and transforms the result into a time-domain signal by an IFFT. Thus, each of an FFT and an IFFT is executed only once on the time-domain input signal in the digital filter circuit 400.

The two types of coefficients used in the filter processing enables minimization of the number of times an FFT and an IFFT are performed. Physical meanings of V(k), W(k), and H(k), and a principle that frequency-domain filter processing equivalent to desired time-domain filter processing is enabled by filter processing using the coefficients C1 (k) and C2(k) generated from V(k), W(k), and H(k) will be described below.

According to the present example embodiment, the complex conjugate generation circuit 415 generates X*(N−k) from a frequency-domain complex signal

X(k)=R(k)+j S(k) (34)

acquired by performing a complex FFT on an input time-domain complex signal x(n) [=r(n)+js(n): formula (1)].

R(k) is a frequency-domain complex signal acquired by transforming a real-part signal r(n) of a real number in a time domain by a real FFT, and S(k) is a frequency-domain complex signal acquired by transforming an imaginary-part signal s(n) of the real number in a time domain by a real FFT. The reason R(k) and S(k) are complex numbers is that FFT processing on a real number results in a complex number. At this time, the following equation holds due to symmetry of complex conjugates.

X*(N−k)=R(k)−jS(k) (35)

Note that X*(N−k) is a complex conjugate of X(N−k).

From equations (14), (34), and (26),

$${X}^{′} ( k ) = X ( k ) \times C 1 ( k ) \qquad ( 36 )$$

$$= \{ R ( k ) + jS ( k ) \} \times \{ V ( k ) + W ( k ) \} \times H ( k )$$

$$= R ( k ) V ( k ) H ( k ) + R ( k ) W ( k ) H ( k ) + jS ( k ) V ( k ) H ( k ) + jS ( k ) W ( k ) H ( k )$$

is acquired.

Further, from equations (17), (35), and (27),

$${X}^{* ′} ( N - k ) = {X}^{*} ( N - k ) \times C 2 ( N - k ) \qquad ( 37 )$$

$$= \{ R ( k ) - jS ( k ) \} \times \{ V ( k ) - W ( k ) \} \times H ( k )$$

$$= R ( k ) V ( k ) H ( k ) - R ( k ) W ( k ) H ( k ) - jS ( k ) V ( k ) H ( k ) + jS ( k ) W ( k ) H ( k )$$

is acquired.

Substitution of equations (36) and (37) into formula (20) yields

$${X}^{″} ( k ) = 1 / 2 \times \{ {X}^{′} ( k ) + {X}^{* ′} ( N - k ) \} \qquad ( 38 )$$

$$= 1 / 2 \times \{ 2 \times R ( k ) V ( k ) H ( k ) + 2 \times jS ( k ) W ( k ) H ( k ) \}$$

$$= R ( k ) V ( k ) H ( k ) + jS ( k ) W ( k ) H ( k )$$

$$= \{ R ( k ) V ( k ) + jS ( k ) W ( k ) \} \times H ( k )$$

formula (38) is an equation representing the signal X″(k) before an IFFT by using the filter coefficients V(k), W(k), and H(k), and R(k) and S(k) in the signal X(k) after the FFT. A complex number includes a real number; and formula (38) is a computation result on a complex number and therefore is a complex number. R(k) is a frequency-domain complex signal acquired by transforming a real-part signal r(n) of a time-domain real number by a real FFT. S(k) is a frequency-domain complex signal acquired by transforming an imaginary-part signal s(n) of the time-domain real number by a real FFT. The reason R(k) and S(k) are complex numbers is that FFT processing on a real number results in a complex number. In other words, formula (38) represents details of filter processing applied to the signal X(k) after the FFT. Formula (38) tells that the digital filter circuit 400 performs processing equivalent to the following three types of filter processing on a frequency-domain complex signal X(k) [=R(k)+jS(k): formula (34)] generated by transforming a complex signal x(n)=r(n)+js(n) by a real FFT.

1) Filter Processing on R(k) with Coefficient V(k)

First, the digital filter circuit 400 performs filter processing with the filter coefficient V(k) on a frequency-domain complex signal R(k) acquired by transforming a time-domain real-part signal r(n) by a real FFT. Accordingly, V(k) is assigned with a frequency-domain complex filter coefficient related to a real filter coefficient when filter processing is performed on the real-part signal r(n) by real computation in a time domain.

2) Filter Processing on S(K) with Coefficient W(K)

Similarly, the digital filter circuit 400 performs filter processing with the filter coefficient W(k) on a frequency-domain complex signal S(k) acquired by transforming a time-domain imaginary-part signal s(n) by a real FFT. Accordingly, W(k) is assigned with a frequency-domain complex filter coefficient related to a real filter coefficient when filter processing is performed on the imaginary-part signal s(n) by real computation in a time domain.

3) Filter Processing on Filter Processing Results of 1) and 2) with Coefficient H(K)

Next, the digital filter circuit 400 performs filter processing with the filter coefficient H(k) on a complex signal R(k)V(k)+jS(k)W(k) including R(k) V(k) and S(k)W(k) after the aforementioned two types of filter processing being independently processed. Note that formula (38) is a computation result on a complex number, and R(k)V(k)+jS(k)W(k) represents a complex number as a whole.

R(k)V(k)+jS(k)W(k) is a frequency-domain complex signal related to a time-domain signal including two signals acquired by independently performing filter processing on the real-part signal r(n) and the imaginary-part signal s(n) in a time domain, respectively. The signals acquired by independently performing filter processing on the real-part signal r(n) and the imaginary-part signal s(n), respectively, correspond to X′(k) and X*′(N−k) in FIGS. 15 and 16. Then, the time-domain signal including r′(n) and s′(n) corresponds to x″(n) in FIG. 13. Thus, R(k)V(k)+jS(k)W(k) is a frequency-domain signal related to a time-domain signal acquired by independently performing filter processing on each of a real part and an imaginary part in a time domain.

Accordingly, the following coefficient may be used in order to perform, on the frequency-domain signal R(k)V(k)+jS(k)W(k), processing corresponding to filter processing on a complex signal by complex computation in a time domain. Specifically, H(k) may be assigned with a frequency-domain complex filter coefficient corresponding to a complex filter coefficient when filter processing is performed on the complex signal x(n) by complex computation in a time domain.

As described above, three types of coefficients are externally set according to the present example embodiment. Specifically, the frequency-domain filter coefficients V(k) and W(k) related to time-domain filter coefficients related to the real part and the imaginary part of a complex signal x(n), respectively, and the frequency-domain coefficient H(k) related to a time-domain filter coefficient related to x(n) are set. By performing filter processing using two coefficients acquired from the aforementioned three coefficients, each of an FFT before the filter processing and an IFFT after the filter processing may be performed only once.

### Advantageous Effect of Third Example Embodiment

As described above, according to the present example embodiment, filter processing using two types of frequency-domain filter coefficients related to time-domain filter coefficients related to the real part and the imaginary part of a complex signal, respectively, and a frequency-domain coefficient related to a time-domain filter coefficient related to the complex signal is performed. Specifically, frequency-domain filter processing related to independent sets of filter processing by real computation performed on the real part and the imaginary part of a complex signal, respectively, in a time domain and filter processing by complex computation performed on a complex signal in a time-domain is performed. Accordingly, desired filter processing can be implemented by using only one each of an FFT circuit performing an FFT before the filter processing and an IFFT circuit performing an IFFT after the filter processing. Consequently, an effect of reducing a circuit scale and power consumption required for performing filter processing is provided.

Furthermore, the FFT device 10 according to the first example embodiment of the present invention or the FFT device 20 according to the second example embodiment of the present invention can be used in implementation of the FFT circuit and the IFFT circuit. As described above, for any value of index k being equal to or greater than 1 and equal to or less than N−1, the FFT circuits according to the example embodiment of the present invention can output X(k) and X(N−k) in the same cycle. Therefore, addition of a circuit for rearrangement in filter processing is not required. Accordingly, an effect of reducing a circuit scale and power consumption required for filter processing is provided by using the FFT circuit according to the example embodiment of the present invention in the filter processing.

### Example Embodiment Based on Superordinate Concept

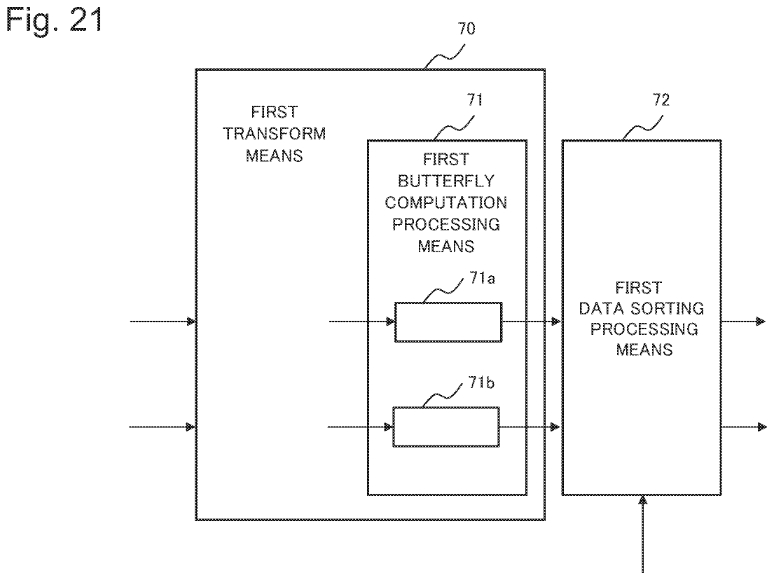

Next, an FFT device according to an example embodiment based on a superordinate concept of the present invention will be described. FIG. 21 is a block diagram illustrating a configuration example of an FFT device according to the superordinate concept of the present invention. The FFT device in FIG. 21 includes a first transform means 70 and a first data sorting processing means 72. The first transform means 70 generates a plurality of sets of a plurality of pieces of first output data performing a fast Fourier transform or an inverse fast Fourier transform and outputs the data in a first order. The first transform means 70 includes a first butterfly computation processing means 71 for performing butterfly computation processing and outputting the plurality of sets of a plurality of pieces of first output data in the first order. Based on an output order setting, the first data sorting processing means 72 rearranges, in a second order, the plurality of sets of a plurality of pieces of first output data output in the first order from the first butterfly computation processing means 71 in the first transform means 70. Furthermore, the first butterfly computation processing means 71 includes a plurality of radix-n butterfly computation processing means 71a and 71b (where n is a multiple of 2) the number of which is equal to or more than the number of the plurality of sets. The plurality of sets of a plurality of pieces of first output data are output from the plurality of radix-n butterfly computation processing means 71a and 71b in the first order.

The first transform means 70 in the FFT device according to the present example embodiment performs rearrangement of a data sequence based on data dependency in an FFT processing algorithm, before the butterfly computation processing by the first butterfly computation processing means 71. A plurality of sets of a plurality of pieces of first output data are output in the first order from the radix-n butterfly computation processing means 71a and 71b in the first butterfly computation processing means 71. Furthermore, the plurality of sets of a plurality of pieces of first output data output in the first order are rearranged in the second order, based on the output order setting, by the first data sorting processing means 72. Thus, the FFT device according to the present example embodiment can output data in any order by specifying the order by using the output order setting. Consequently, a fast Fourier transform device with low processing latency in digital signal processing using a fast Fourier transform and with a small circuit scale and low power consumption of a circuit for implementing the digital signal processing can be provided.

While the preferred example embodiments of the present invention have been described above, the present invention is not limited to these example embodiments. It goes without saying that various modifications may be made within the spirit and scope of the invention as defined in the claims and such modifications are also included in the spirit and scope of the present invention.

This application is based upon and claims the benefit of priority from Japanese patent application No. 2020-55544, filed on Mar. 26, 2020, the disclosure of which is incorporated herein in its entirety by reference.

### REFERENCE SIGNS LIST

10, 20 FFT device
11, 13 First data sorting processing unit
12, 14 Second data sorting processing unit
21, 23 First butterfly computation processing unit
22, 24 Second butterfly computation processing unit
21a, 21b, 22a, 22b, 23a, 23b, 23c, 24a, 24b, 24c Radix-8 butterfly computation processing unit
31, 32 Twiddle multiplication processing unit
41, 42 Read address generation unit
51, 53 Read address
52, 54 Output order setting
100, 200 Data sorting processing unit
101a to 101h Data storage location
102a to 102h Data read location
201a to 201h Data storage location
202a to 202h Data storage location
400 Digital filter circuit
413 FFT circuit
414 IFFT circuit
415 Complex conjugate generation circuit
416 Complex conjugate synthesis circuit
421 Filter circuit
422 Filter circuit
431 to 436 Complex signal
441 Filter coefficient generation circuit
445, 446 Complex signal
500 Dataflow
501 Data sorting processing
502, 503 Butterfly computation processing
504 Twiddle multiplication processing
505 Partial dataflow
600 FFT device
601 FFT unit
602 Data sorting processing unit

What is claimed is:

1. A fast Fourier transform device comprising:
a first transform unit that generates a plurality of sets of a plurality of pieces of first output data by performing a fast Fourier transform or an inverse fast Fourier transform and outputting the generated data in a first order, the first transform unit including first butterfly computation processing unit that performs butterfly computation processing and outputting the plurality of sets of a plurality of pieces of first output data in the first order; and
a first data sorting processing unit that, based on an output order setting, rearranges, in a second order, the plurality of sets of a plurality of pieces of first output data output in a first order from the first butterfly computation processing unit in the first transform unit, wherein
the first butterfly computation processing unit includes a plurality of radix-n butterfly computation processing unit (where n is a multiple of 2) a number of which is equal to or more than a number of the plurality of sets, and the plurality of sets of a plurality of pieces of first output data are output in the first order from the plurality of radix-n butterfly computation processing unit.

2. The fast Fourier transform device according to claim 1, wherein,
when the plurality of pieces of first output data are denoted by X(k) (where k is an integer satisfying 0≤k≤N−1 and N is a number of one or more points in a fast Fourier transform or an inverse Fourier transform and satisfies N>0), the first data sorting processing unit outputs X(k) and X(N−k) in a same cycle for any k.

3. The fast Fourier transform device according to claim 1, wherein,
when the plurality of pieces of first output data are denoted by X(k) (where k is an integer satisfying 0≤k≤N−1 and N is a number of one or more points in a fast Fourier transform or an inverse Fourier transform and satisfies N>0), the first data sorting processing unit outputs X(k) and X(N−k) with a time difference within one cycle for any k.

4. The fast Fourier transform device according to claim 1, wherein
the first data sorting processing unit
includes a first storage unit that stores the N pieces of second input data and a read address generation unit that generates read addresses of the N pieces of first output data from the first storage unit, based on an output order setting and
stores the plurality of pieces of second input data in the first order and reads the plurality of pieces of second input data in the second order.

5. The fast Fourier transform device according to claim 1, further comprising:
a twiddle multiplication processing unit that performs twiddle multiplication processing on the plurality of sets of a plurality of pieces of first output data output in the first order from the first data sorting processing unit; and
a second butterfly computation processing unit that performs butterfly computation processing on data from the twiddle multiplication processing unit and outputs the resulting data.

6. The fast Fourier transform device according to claim 5, wherein
the second butterfly computation processing unit includes a plurality of radix-n butterfly computation processing unit (where n is a multiple of 2) a number of which is equal to or more than a number of the plurality of sets, and the plurality of sets of a plurality of pieces of first output data are output in the first order from the plurality of radix-n butterfly computation processing unit.

7. A digital filter device comprising:
the fast Fourier transform device according to claim 1;
a complex conjugate generation unit that generates second complex data including a conjugate complex number for every complex number constituting a plurality of pieces of frequency-domain first complex data generated by the fast Fourier transform device by Fourier-transforming the plurality of pieces of first input data being input time-domain complex numbers;
a filter coefficient generation unit that generates first and second frequency-domain filter coefficients being complex numbers from input first, second, and third input filter coefficients being complex numbers;
a first filter unit that performs filter processing on the first complex data with the first frequency-domain filter coefficient and outputting third complex data;
a second filter unit that performs filter processing on the second complex data with the second frequency-domain filter coefficient and outputting fourth complex data; and
a complex conjugate synthesis unit that generates fifth complex data by synthesis from the third complex data and the fourth complex data.

8. A fast Fourier transform method comprising:
when generating a plurality of sets of a plurality of pieces of first output data by performing a fast Fourier transform or an inverse fast Fourier transform and outputting the generated data in a first order, performing butterfly computation processing and outputting the plurality of sets of a plurality of pieces of first output data in the first order; and,
based on an output order setting, rearranging, in a second order, the plurality of sets of a plurality of pieces of first output data output in the first order, wherein,
in the butterfly computation processing, the plurality of sets of a plurality of pieces of first output data are output in the first order by a plurality of sets of radix-n butterfly computation processing by a plurality of radix-n butterfly computation processing unit (where n is a multiple of 2) a number of which is equal to or more than a number of the plurality of sets.
